(19) United States
(12) Patent Application Publication
(10) Pub. No.: US 2006/0162300 A1
(43) Pub. Date: Jul. 27, 2006

(54) Filtering device

(75) Inventor: Assar Sharifi, Lyckselse (SE)

Correspondence Address: YOUNG & THOMPSON, 745 SOUTH 23RD STREET, 2ND FLOOR, ARLINGTON, VA, 22202, US

(73) Assignee: Plymovent AB, Lyckselse (SE)

(21) Appl. No.: 10/524,540

(22) PCT Filed: Aug. 12, 2003
(86) PCT No.: PCT/SE03/01266

§ 371 Date: Feb. 14, 2005

(30) Foreign Application Priority Data
Aug. 12, 2002 (SE) 0202395-0

(51) Int. Cl. B01D 46/00

(52) U.S. Cl. 55/350.1

(57) ABSTRACT

An air filtering device and a method of producing the device. The device is constructed from a number of modules of a first module type (4) and a second module type (6), which are arranged in series in a row. A module of the first module type (4) is arranged as an inlet module (4) with inlets (42), which is connected in series to modules (8, 10: 16) of the second module type (6). One of the latter may include a fan element (18) or one or more filter elements (12, 14), and one of them is arranged as an outlet module (16) and others as through-flow modules (8, 10). The modules are joined together by locking members (32) arranged in each module, in such a way that the modules create an enclosed air duct (4, 8, 10, 16).

### TECHNICAL FIELD

The present invention relates to a method and a device for filtering polluted air, for example in manufacturing industry or the like, of the type set forth in the independent claims. The polluted air may in some cases contain particles of varying size in both solid, liquid and gaseous form and is usually led off by means of a local extraction device, for example, from the pollution source to the filtering device via one or more ducts (pipes, hoses, etc.). After treatment, the filtered air is suitably returned directly to the premises in question, or is led off via a suction line to an external fan. A filtering device of this type therefore generally comprises an inlet part with mechanical filters, for example preliminary filters and a mechanical preliminary separator, followed by one or more other filters and,. where necessary, a fan unit. For various spheres of application, filters with different characteristics are required, such as fine filters, carbon filters, hepa filters, electrostatic cells, bag filters etc.

### PRIOR ART

Known filtering devices of the aforementioned type are usually constructed with a structure of constituent elements (for example, various types of filter, preliminary separator, fan unit) fixed during manufacture, the elements being assembled to form a fixed structure by means of either non-releasable connections or various separate fasteners, which usually require various tools for assembly. In addition, various types of welding operations are generally performed with the aim of ensuring the requisite degree sealing between constituent parts of the filtering device. With conventional engineering therefore each filtering device is constructed expressly for its specific filter combination, and even changing a filter can therefore involve a relatively complicated and costly operation. Where a need arises for filters with alternative characteristics or alternative combinations of filters and/or between filters and any fan units, it has hitherto been necessary to construct a new filter device from scratch.

### ADVANTAGES OF THE INVENTION

The filtering device according to the invention affords the following advantages:
a) The modules can be joined together without any welding operation,
b) The joining can be performed without separate fasteners using only one tool,
c) Optimum sealing action due to a new method of fixing filter elements,
d) The body of the module forms a carrier for the elements, which means that most elements fit into the module without any additional components,
e) The design of the fan element forming part of one variant is based on the same principle as our Swedish patent application 0200033-9 relating to a fan housing (fan shroud TEV model),
f) Only two types of module are used to produce solutions suited to a large number of applications.

### SUMMARY OF THE INVETION

The object of the invention is therefore to provide simpler and more flexible solutions than hitherto to specific applications of filtering devices by means of a modular system. This is achieved in that an air filtering device is produced in the following stages:
a number of modules, which have housings of identical cross-section and comprise at least a first module type and a second module type are arranged in series in a row,
a module of the first module type, which has at least one inlet, is arranged as an inlet module and is connected in series to at least two modules of the second module type, of which at least one contains filter elements,
of at least two modules of the second module type, one is arranged as an outlet module and at least one as a through-flow module,
the modules are joined together by means of locking members arranged in each module, in such a way that the modules create an enclosed air duct.

In this way it is possible, from just two basic modules, to produce a flexible, modular filtering device, which can be easily converted and supplemented in order to adapt it to different requirements, and the modules of which with their constituent elements, in particular the filter elements, are easily replaceable and interchangeable with one another.

An air filtering device constructed in this way is characterized by the following features: that a number of modules having housings of identical cross-section and comprising at least a first module type and a second module type are arranged in series in a row, that a module of the first module type is arranged as an inlet module having at least one inlet, that the inlet module is connected in series to at least two modules of the second module type, at least one of which comprises filter elements, and

of which one is arranged as an outlet module and at least one as a through-flow module, and that the modules are joined together by means of locking members arranged in each module, in such a way that the modules have created an enclosed air duct.

Further objects of the invention and advantageous developments and enhancements of the invention are set forth in the dependent claims and in the following description.

### DESCRIPTION OF THE DRAWINGS

The invention will be explained in more detail in the following description with reference to diagrams attached. Identical parts have the same reference numbers.

FIG. 1 shows an example of an air filtering device according to the invention produced by the method according to the invention, in an oblique perspective view of the modular filtering device from above,

FIG. 2 shows a plan view from directly in front of the open front side of the filtering device in FIG. 1, with elements situated in the module housings,

FIG. 3 shows a side view of the filtering device in FIG. 2 with front panels fitted and

FIG. 4 to 8 show examples of various constituent parts of the filtering device in FIG. 1 to 3.

### DETAILED DESCRIPTION

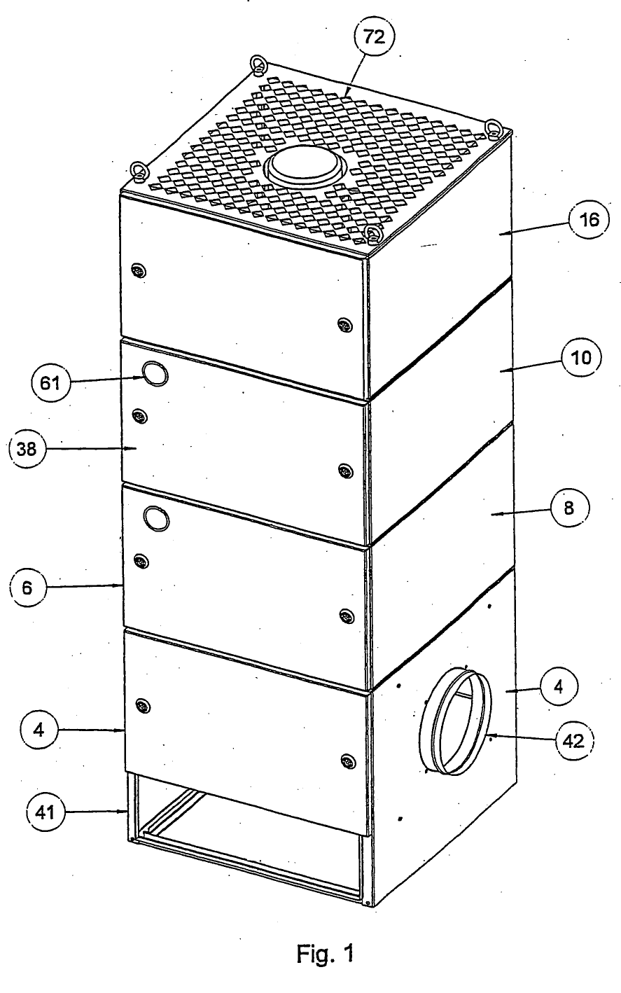

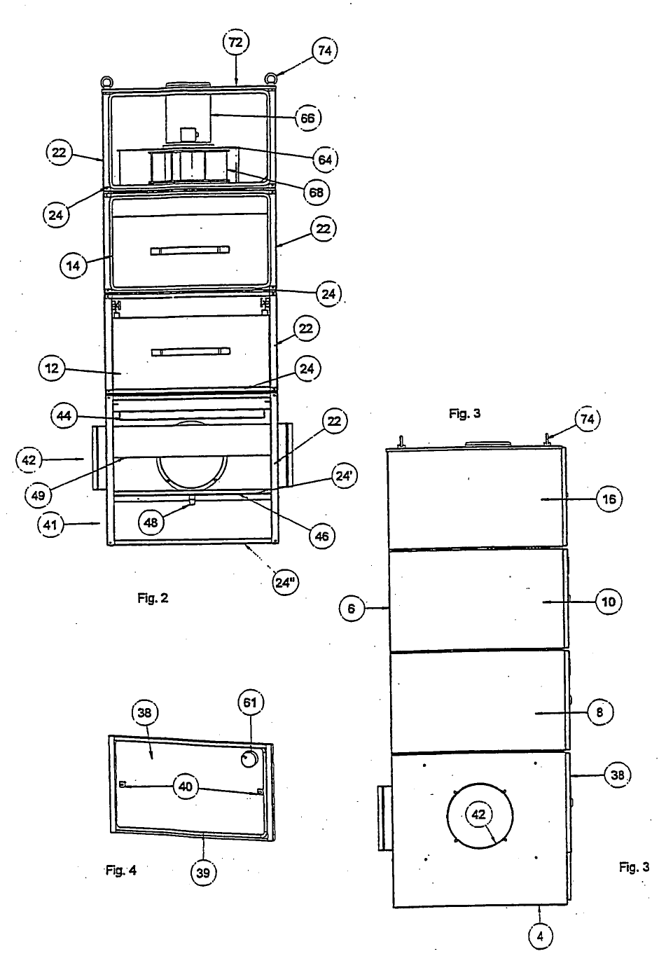

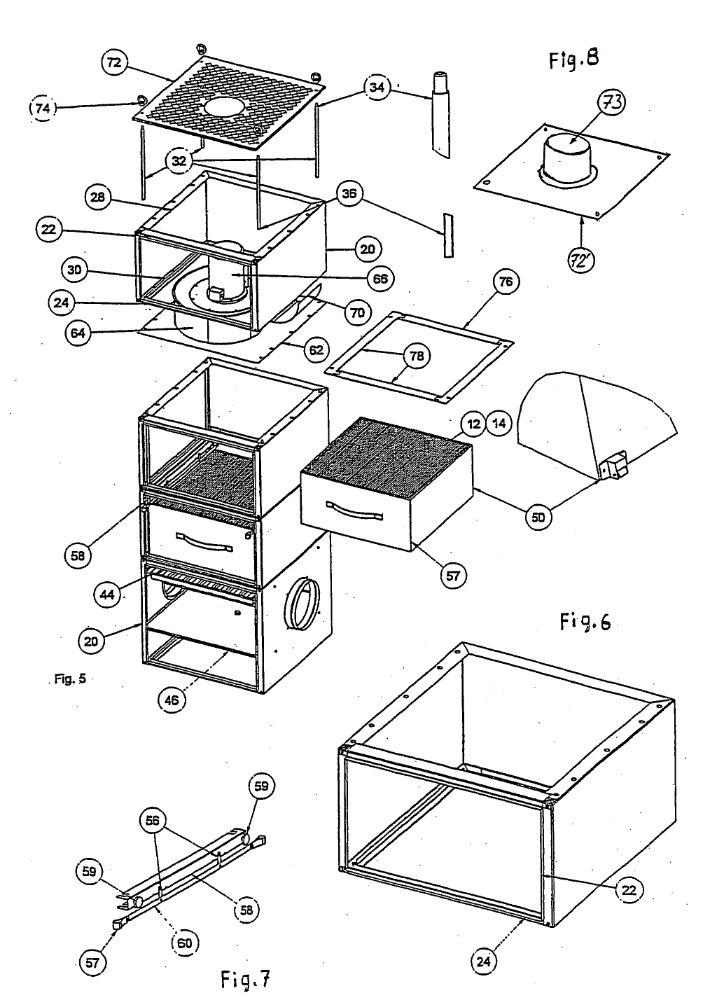

According to the example in FIG. 1-4 the filtering device is constructed by arranging four modules, which have housings of identical cross-section and comprise a first module type 4 and a second module type 6, in series in a row. A module of the first module type 4 forms an inlet module 4, which is connected in series to three modules of the second module type 6, two of which are arranged as a first through-flow module 8 and one as a second through-flow module 10, which in order comprise the first filter element 12 and second filter element 14, whilst the third is arranged as an outlet module 16. If the filtered air is to be returned to the premises, the outlet module 16 comprises a fan element 18. If the filtered air is to be led off to an external fan, the fan element is not required and can be omitted. The outlet module 16 may then instead comprise either of the filter elements 12, 14 or be simply arranged for connection to the external fan via a suction line (not shown).

As can best be seen from FIG. 5, each module, regardless of the module type, is constructed from correspondingly designed housings 20. The construction of the first module type, the inlet module 4, will be described in more detail later. Instead the second module type 6 will now be described as an example of the general design of the housing 20, which has a body 21 formed from L-shaped profiles, for example, with a vertically aligned front framework 22 and a horizontally aligned lower framework 24, on which body a solid wall 26 is fitted on three sides of the housing by conventional means, for example by means of screwed connections, flanging, welded joints or the like. The body 21 and the wall 26 may be conventionally made of metal (sheet metal, sheet metal profiles), the wall preferably having been manufactured in one piece by bending of a sheet metal fabrication. At the same time the top edges of the wall 26 have been bent in at an angle, so that an upper assembly seam 28 has been formed around an upper open side of the housing 20. In assembling in the manner described above, for example, the front and bottom edges of the wall have been anchored to the front framework 22 and lower framework 24 of the body 21, which are made from L-shaped profiles, for example. Where necessary, these wall edges too, like the top edges of the wall, may have been bent so that a corresponding lower assembly seam 30 has been formed around a lower open side of the housing 20.

At preferably each corner of the housing 20 there is a locking member 32 in the form of a tubular element, which extends from the upper assembly seam 28, along the corner and through the lower framework 24 to the lower assembly seam 30. The locking members 32 are intended for joining together two adjacent housings of identical cross-section arranged in series in a row, for example two housings 20 that are to be assembled in order to form part of a filtering device 2. At its upper end, each locking member 32 is designed with a threaded pin 34, which has an internal hexagonal socket. At the bottom end the locking member is designed with a hollow sleeve 36, which has an internal thread corresponding to the pin.

Locking members 32 belonging to the housing may advantageously be rotatably fitted in holes made for this purpose in the lower framework 24 and in the upper assembly seam 28 and the lower assembly seam 30 formed from the bent edges of the wall. Here the diameter of each hole must allow each threaded pin 34 to pass through both the upper assembly seam 28 and the lower assembly seam 30, whilst the tubular element and hollow sleeve 36 of the associated locking member 32 are restrained by the respective assembly seam. For this purpose, therefore, each hole made in the lower framework should have a diameter which is somewhat greater than the diameter of the hollow sleeve 36. In this way locking members 32 are always enclosed in the housing 20, thereby eliminating the disadvantages associated with loose fasteners.

An open side defined by the front framework 22 can be closed by means of a front panel 38 which can be fitted in a similarly conventional manner and which can likewise be made in a known way from a sheet metal, the ends of which are bent on two levels. Fitted to the inside of the front panel is a rectangular, suitably injection-moulded packing 39 known in the art, which when the front panel is in the fitted position conforms to the front framework 22. The front panel 38 can be fixed with the packing 39 to bear tightly against the front framework 22, for example by means of two conventional locking elements 40 of the eccentric lock, wing lock, snap lock or screwed connection type etc. The requisite contact pressure is produced by arranging each of the two locking elements 40 in close proximity to the corresponding short sides of each front panel 38 and on a centre-line that extends between them, and bringing these into engagement with vertical profiles of the front framework 22. It is thereby possible to produce a housing 20, which has two opposing ends and which is enclosed by the wall 26 on three sides and on the fourth side by the removable front panel 38.

The module of the first module type, the inlet module 4, is constructed from a similar housing 20′ to the modules 6 of the second module type. One difference is that the lower framework 24′ has been extended downwards with further vertical profiles extending downwards, which rest on a similar bottom framework 24″ and the wall 26′ covering three sides has been made correspondingly higher, so that a bottom section 41 has been produced on the housing 20′, which has thereby also become corresponding higher. The open side defined by the front framework 22 can here also be closed by means of a similarly attachable front panel 3 8. The bottom section 41, however, preferably has an open front side.

Immediately above the lower framework 24′ the inlet module 4 has three selectable inlets 42, two of which are situated laterally opposite one another and one on the rear side of the inlet module 4. Extending between the opposing inlets is a plate of semi-cylindrical shaped design, which forms an arched cover between the inlets, which constitutes a first separating chamber 49 in the inlet module 4. The third inlet does not have a separating chamber. Unused inlets 42 are suitably closed by means of a cover plate, cap or the like (not shown). The optimum effect is therefore achieved by using one of the opposing inlets 42. In this way it is possible achieve a certain separation of liquid particles, such as oil, from the air in the very first stage by means of the first separating chamber 49.

The inlet module 4 is furthermore provided in a known manner above the inlets 42 with a primary filter element 44, which preferably has three conventional mechanical filter stages (not shown in detail). In addition, the height of the inlet module 4, immediately below the three inlets 42, is divided by a plate 46 for collecting liquid pollutants. The plate 46 is preferably fixed to the wall 26′ of the module 4 by conventional fasteners. The plate 46 is arranged with drainage towards a centrally made drainage hole 48, which leads to the bottom section 41 and which may be provided with a tap or shut-off valve (not shown). For collecting the pollutants a vessel (not shown) may be situated in the bottom section 41 below the drainage hole 48 in the plate, or the pollutants can be led off by means of a fitted pump (likewise not shown here).

A module of the second module type 6 may alternatively be equipped with either a) a filter element 12, 14 or b) a fan element 18 and arranged as c) a through-flow module 8, 10 or as d) an outlet module 16. The outlet module 16 may therefore alternatively be equipped with either a fan element 18 or first filter element 12 and/or second filter element 14 or may simply be arranged with an outlet for connection of a suction line (not shown) taken to an external fan.

For alternative a), the filter element 12, 14 may be fitted directly to the lower frame 24 of the module, the filter element on either side of its rear end having a friction-reducing device known in the art, such as a rear roller device 50, which can be made to run on a corresponding profile of the lower framework 24. This prevents its seal of known type (not shown), with which the filter element is usually provided, from being damaged during assembly. When the filter element has assumed its final assembly position, the seal bears against the lower framework 24. When the fan element 18 or the externally located fan is set in operation, a negative pressure is created in the modules 4, 8, 10, which generates a lifting force on the filter element 12, 14. In order to prevent this force lifting the filter element out of position, a fastener 58 can be fitted to each side of the filter element. The fastener 58 is formed as a U-shaped bar, the flanges of which in proximity to each short end are each provided with a hook-shaped recess, which each correspond to a pair of locking members 32 on either side of the module. In addition, the fastener 58 has an L-shaped bar 60 pivotally suspended by means of two articulated arms 56 that are preferably made of sheet metal. The bar 60 is preferably made of sheet metal bent to an L-shaped profile, and through the action of a grip 57 is moveable forwards and backwards in a pendulum motion. The grip may take the form, for example of a thin plastic strap or may be arranged at each end of the L-shaped bar 60.

The fastener 58 is introduced on top of the filter unit along each side of the module with the respective locking member situated in a corresponding recess therein and screwed tight to the locking members 32 by means of a lock screw 59 arranged adjacent to each hook of the respective recess. The lock screw has a head in the form of a wheel and at its other end a so-called rivet nut (not shown). Before the lock screw is tightened, the fastener must be pressed forwards so that the locking members are hooked up by the associated hook and the screw 59 is then tightened with the rivet nut bearing against the locking member. The distance between the fastener 58 and the filter element 12, 14 is thereby adjusted so that the L-shaped bar 60 presses against the top of the filter element when the L-shaped bar is suspended in its lowest pendulum position and the L-shaped bar bears with one end against the rear wall side of the module housing. The front panel 38 is then fitted, which means that the L-shaped bar will come to bear against this with the other end and is thereby prevented from pivoting out of its lowest pendulum position. The filter element 12, 14 is therefore firmly anchored in the module. This prevents the filter element coming loose from the lower framework 24 with ensuing leakage when a negative pressure occurs in operation.

To replace a filter, the front panel 38 is removed and the L-shaped bar 60 is pivoted out of its bottom pendulum position by the operator pulling the grip 57 outwards from the module. The filter is thereby released and can be replaced with a new one. Each filter element 12, 14 in a module of the second module type 6 can therefore also be individually exchanged for cleaning or in order to replace it with a new one of the same type or another filter element with alternative characteristics suited to the relevant requirement.

The filter element is therefore fitted virtually free of leakage, in tight sealing contact with the lower framework 24. For registering and indicating the degree of contamination inside the module and in particular of the filter element, a contamination indicator 61 of conventional type is fitted directly in the associated front panel 38. This is possible due to the sealed fitting of the filter element as described above, which allows the indicator 61 to be situated adjacent to the air flow where there is no risk of its being damaged by the passing air pollutants. It is thereby possible to read off the current status of each filter element from the outside of the front panel.

For alternative b) the fan element 18 may comprise a fan housing 64 with its air inlet end integrally formed with a so-called sandwich plate 62 with corresponding inlet opening, and has a fan motor 66, on the shaft of which is fitted a radial-type fan impeller 68. The outlet air chamber of the fan housing 64 with air outlet is then arranged inside the housing 20 of the module and a deflector plate 70, which deflects the outlet air upwards through the housing 20, can be arranged on that side of the sandwich plate 62 facing the inside of the housing. By means of the sandwich plate 62 in which holes are made corresponding to holes situated in assembly seams 28, 30 of the housing 20, the fan element 18 can be fixed by means of the housing locking member 32 between the lower assembly seams 30 on this housing and the upper assembly seams 28 on an adjoining housing 20, 20′. The fan element 18 may preferably be constructed on the same principle as has been described in our Swedish patent application 0200033-9.

Finally for alternative c) and d), a module of the second module type 6, which is equipped according to a) or b), may therefore be arranged as one of the through-flow modules 8, 10 for alternative c) and arranged as outlet nodule 16 for alternative d). The outlet module 16, which therefore constitutes the uppermost module of the filtering device, is provided, if equipped according to alternative b), with an air-permeable cover plate 72, which may be perforated or provided with a screen, lattice or mesh in order to serve as a protective diffuser. The cover plate 72 has holes, corresponding to the holes made in the upper assembly seam 28 of the housing 20, for the threaded pins 34 on the housing locking members 32 and is fixed to the top of the outlet module 16 by means of nuts 74 that can be screwed onto each pin 34, for example nuts provided with loops, which can be used as lifting loops for suspending the filtering device. As shown by the example described, a recess conforming to the fan motor may, if necessary, be made in the centre of the cover plate 72.

If the outlet module 16 is equipped according to alternative a) or if it is merely arranged for connection of a suction line (not shown) taken to an external fan, it is instead provided with an airtight cover plate 72′, which is fitted using the same parts as described above for the air-permeable cover plate 72. Instead of the recess conforming to the fan motor, the cover plate 72′ has a corresponding recess. This recess is provided with a union connection piece (73) attached by conventional means, for example by welding, for connection of the suction line to the externally located fan (not shown).

When assembling the filtering device, two modules are first placed one vertically on top of the other with a sealing plane 76 between adjoining modules. The sealing plane 76 is preferably formed from four sealing parts 78 cut to shape, which are fitted beforehand to each upper assembly seam 28. The threaded pins 34 of each locking member 32 then serve as guide pins, which prevent damage to the sealing plane during assembly. When the modules have assumed their correct position relative to one another, the four locking member 32 are locked from above by tightening using a key intended for this purpose, which means that the sealing plane is compressed between the modules and a connection affording optimum tightness is achieved. Further modules are then correspondingly assembled one at a time until the required number has been reached.

The three modules of the second module type 6, two of which are arranged as a first through-flow module 8 and a second through-flow module 10, whilst the third is arranged as an outlet module 16, have identical housings 20 and are thereby interchangeable with one another. In addition, the module of the first module type, the inlet module 4, has a housing 20′ of identical cross-section to each housing 20 of the three modules of the second module type 6, which form carriers for the fan element 18 and the first and second filter elements 12 and 14 respectively. This makes it easy to join the inlet module 4 together with the said three modules in any order, to produce a filtering device 2 having the required characteristics. The first through-flow module 8 and the second through-flow module 10 are then usually equipped with the first filter element 12 and the second filter element 14 respectively and the fan element 18 is fitted in the outlet module 16. It is nevertheless possible to arrange the modules and/or their equipment in some other order according to the actual requirement.

Even through the filtering device in the example described is constructed from the inlet module 4, the two through-flow modules 8, 10 with associated filter elements and the outlet module 16 with outlet and with or without the fan element 18, any number of modules with alternative elements may naturally be assembled in series in a row in any order. This makes it possible to produce filtering devices which are suited to widely differing spheres of application.

It will be appreciated that the first filter element 12 and the second filter element 14 according to the invention in the exemplary embodiment may consist of or contain the requisite filters for various spheres of application, including those stated in the introductory part, that is mechanical separators, preliminary filters, fine filters, carbon filters, heap filters, electrostatic cells, bag filters, etc,

The modular construction according to the invention is highly suited to both floor-mounted and roof or wall-mounted and mobile filtering devices. Even though the example described shows a filtering device which is constructed from a module of a first module type and three modules of a second module type, which are arranged in series in a row, a person skilled in the relevant art will appreciate that further module types, which are constructed from correspondingly designed housings, may be feasible. It is therefore possible, depending on the sphere of application, to arrange modules of varying module type in the filtering device. Furthermore the number of modules of each module type may obviously vary.

The filtering device may therefore be constructed from one module of a first module type (inlet module) and just one or two modules of a second module type (one through-flow module and one outlet module or a combined through-flow and outlet module).

1-39. (canceled)

40. Method of producing an air filtering device, characterized by the following stages:
a number of modules, which have housings of identical cross-section and comprise at least a first module type (4) and a second module type (6) are arranged in series in a row,
a module of the first module type (4), which has at least one inlet (42), is arranged as an inlet module (4) and is connected in series to at least two modules (8, 10: 16) of the second module type (6), at least one of which contains filter elements (12, 14),
of at least two modules of the second module type (6), one is arranged as an outlet module (16) and at least one as a through-flow module (8, 10),
the modules are joined together by means of locking members (32) arranged in each module, in such a way that the modules create an enclosed air duct (4, 8, 10, 16).

41. Method according to claim 40, characterized in that for each module (4, 6) a housing (20) is manufactured by forming a body (21) with a front framework (22) and a lower framework (24), around which body a wall (26) is fitted covering three sides of the housing.

42. Method according to claim 41, characterized in that an upper assembly seam (28) is formed around an upper open side of the housing (20).

43. Method according to claim 42, characterized in that a lower assembly seam (30) is formed around a lower open side of the housing (20).

44. Method according to claim 43, characterized in that two adjacent housings (20) are joined together by means of locking members (32) arranged in each housing.

45. Method according to claim 44, characterized in that the locking members (32) are fitted in holes made for this purpose in the lower framework (24) and in the upper assembly seam (28) and the lower assembly seam (30).

46. Method according to claim 45, characterized in that each locking member (32) is formed as a tubular element with a threaded pin (34) at an (upper) end and at the (other) lower end as a hollow sleeve (36) having an internal thread corresponding to the pin.

47. Method according to claim 46, characterized in that each locking member (32) is fitted into the holes made for this purpose in such a way that the locking member is fitted so that it can rotate in relation to the lower framework (24) and the upper assembly seam (28) and the lower assembly seam (30), whilst the locking member (32) is restrained between the assembly seams (28, 30).

48. Method according to claim 41, characterized in that an open side of the housing (20) defined by the front framework (22) is closed by means of a front panel (38).

49. Method according to claim 48, characterized in that the front panel (38) is provided with a packing (39), which is made to bear tightly against the front framework (22) by bringing locking elements (40) into engagement with the front framework (22).

50. Method according to claim 40, characterized in that the inlet module (4) is provided with inlets (42), above which a primary filter element (44) is arranged and below which the height of the inlet module is divided by a plate (46) for collecting liquid pollutants.

51. Method according to claim 40, characterized in that a filter element (12, 14) is fitted directly to the lower framework (24) of the module of the second module type (6) by means of a device (50), which is made to run thereon.

52. Method according to claim 51, characterized in that the filter element (12, 14) is made to assume its final assembly position with the underside thereof fitted in tight sealing contact with the lower framework (24).

53. Method according to claim 52, characterized in that on either side of the filter element (12, 14) fasteners (58) are fitted which are fixed to the locking members (32), by means of which the filter element (12, 14) is anchored in the module.

54. Method according to claim 53, characterized in that a contamination indicator (61) is fitted in the associated front panel (38) for registering and indicating the degree of contamination of the filter element (12, 14).

55. Method according to claim 40, characterized in that a module of the second module type (6) is provided with a fan element (18), the fan housing (64) of which at its air inlet end is integrated with a sandwich plate (62), which is fitted between the assembly seams (28, 30) on two adjacent housings (20, 20′) for modules of the second module type (6).

56. Method according to claim 51, characterized in that the module of the second module type (6) is arranged as a through-flow module (8, 10).

57. Method according to claim 51, characterized in that the module of the second module type (6) is arranged as an outlet module (16).

58. Method according to claim 57, characterized in that the outlet module (16) is provided with an air-permeable cover plate (72), which is fixed to the top of the outlet module by means of nuts (74), which are provided with loops and can be connected to the locking members (32).

59. Method according to claim 40, characterized in that in assembling the filtering device a sealing plane (76) is fitted between adjoining modules (4, 6).

60. Air filtering device, characterized in that a number of modules, which have housings of identical cross-section and comprise at least a first module type (4) and a second module type (6) are arranged in series in a row, that a module of the first module type (4) is arranged as an inlet module (4) having at least one inlet (42), that the inlet module (4) is connected in series to at least two modules (8, 10: 16) of the second module type (6), at least one of which contains filter elements (12, 14), and one of which is arranged as an outlet module (16) and at least one as a through-flow module (8, 10), and that the modules are joined together by means of locking members (32) arranged in each module, in such a way that the modules create an enclosed air duct (4, 8, 10, 16).

61. Air filtering device according to claim 60, characterized in that each module (4, 6) has a housing (20) with a body (21), which id formed with a front framework (22) and a lower framework (24), around which body a wall (26) is fitted covering three sides of the housing.

62. Air filtering device according to claim 61, characterized in that an upper assembly seam (28) is formed around an upper open side of the housing (20).

63. Air filtering device according to claim 62, characterized in that a lower assembly seam (30) is formed around a lower open side of the housing (20).

64. Air filtering device according to claim 63, characterized in that two adjacent housings (20) are joined together by means of locking members (32) arranged in each housing.

65. Air filtering device according to claim 64, characterized in that the locking members (32) are fitted in holes made for this purpose in the lower framework (24) and in the upper assembly seam (28) and the lower assembly seam (30).

66. Air filtering device according to claim 65, characterized in that each locking member (32) is formed as a tubular element with a threaded pin (34) at an (upper) end and at the (other) lower end as a hollow sleeve (36) having an internal thread corresponding to the pin.

67. Air filtering device according to claim 66, characterized in that each locking member (32) has been fitted into the holes made for this purpose in such a way that the locking member is fitted so that it can rotate in relation to the lower framework (24) and the upper assembly seam (28) and the lower assembly seam (30) whilst the locking member (32) is restrained between the assembly seams (28, 30).

68. Air filtering device according to claim 61, characterized in that an open side of the housing (20) defined by the front framework (22) is closed by means of a front panel (38).

69. Air filtering device according to claim 68, characterized in that the front panel (38) is provided with a packing (39), which has been made to bear tightly against the front framework (22) by bringing locking elements (40) into engagement with the front framework (22).

70. Air filtering device according to claim 60, characterized in that the inlet module (4) has inlets (42), above which a primary filter element (44) is arranged and below which the height of the inlet module is divided by a plate (46) for collecting liquid pollutants.

71. Air filtering device according to claim 60, characterized in that a filter element (12, 14) is fitted directly to the lower framework (24) of the module of the second module type (6) by means of a roller device (50), which is made to run thereon.

72. Air filtering device according to claim 71, characterized in that the filter element (12, 14) has been made to assume its final assembly position with the underside thereof fitted in tight sealing contact with the lower framework (24).

73. Air filtering device according to claim 72, characterized in that on either side of the filter element (12, 14) fasteners (58) are fixed to the locking members (32), by means of which the filter element (12, 14) is anchored in the module.

74. Air filtering device according to claim 73, characterized in that a contamination indicator (61) is fitted in the associated front panel (38) for registering and indicating the degree of contamination of the filter element (12, 14).

75. Air filtering device according to claim 60, characterized in that a module of the second module type (6) comprises a fan element (18), the fan housing (64) of which at its air inlet end is integrated with a sandwich plate (62), which is fitted between the assembly seams (28, 30) on two adjacent housings (20, 20′) for modules of the first or second module type (4, 6).

76. Air filtering device according to claim 71, characterized in that the module of the second module type (6) is arranged as a through-flow module (8, 10).

77. Air filtering device according to claim 71, characterized in that the module of the second module type (6) is arranged as an outlet module (16).

78. Air filtering device according to claim 77, characterized in that the outlet module (16) is provided with an air-permeable cover plate (72), which is fixed to the top of the outlet module by means of nuts (74), which are provided with loops and are connected to the locking members (32).

79. Air filtering device according to claim 60, characterized in that a sealing plane (76) is fitted between each module (4, 6).
